(19) United States
(12) Patent Application Publication
(10) Pub. No.: US 2008/0224863 A1
(43) Pub. Date: Sep. 18, 2008

(54) Method for Monitoring a Room and an Apparatus For Carrying Out the Method

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/088,742

(22) PCT Filed: Sep. 29, 2006
(86) PCT No.: PCT/EP06/66893

§ 371 Date: Mar. 31, 2008

(30) Foreign Application Priority Data
Oct. 7, 2005 (CH) 01626/05

(51) Int. Cl. G08B 13/00

(52) U.S. Cl. 340/541

(57) ABSTRACT

A method for monitoring a room (R) is specified, in which acoustic properties (\textcircled{S}, W) of the room (R) are determined, changes (δ) in the acoustic properties (\textcircled{S}, W) of the room (R) are detected, the changes (δ) are compared with prescribed criteria (Δ\textcircled{S}, ΔW)and an action (α) is triggered if the prescribed criteria (Δ\textcircled{S}, ΔW) have been satisfied. This makes it possible to monitor a room with the aid of an active noise reduction system. If there is no need to monitor a room, the system can be used for active noise reduction.

### RELATED APPLICATION

This is a U.S. national phase application under 35 U.S.C. §371 of International Application No. PCT/EP2006/066893 filed Sep. 29, 2006 and claiming priority of Switzerland Application No. 01626/05 filed Oct. 7, 2005.

### TECHNICAL FIELD

The present invention relates to a method for surveying a room, a use of the method, a device for carrying out the method as well as a use of the device.

### BACKGROUND AND SUMMARY

Such methods and devices are known in a great number, whereas so-called motion detectors are applied triggering an alarm as soon as a person gets into the surveyed room. Often, the used motion detectors measure the emission in the infrared wave range in order to prevent false alarms by falling objects.

The present invention is based on an exploitation of acoustic properties of a room and accordingly breaks new ground in the technical field of room surveying.

Each room has individual acoustic properties, which can be depicted using an “impulse response of the room” or a transfer function, respectively. In modifying the geometry of the room, the respective transfer function is correspondingly modified as well. The characteristic of a room is modified when opening and closing doors or windows, for example, or when furniture or other furnishing are displaced in the room or removed from the room, respectively. Further, the transfer function of the room is also modified, when people enter the room or leave it, or when people go to another place in the room, respectively. Therefore, every modification in the room causes a correspondent modification of the impulse response or the transfer function, respectively, which describes the acoustic behaviour of the room.

The method according to the present invention for surveying a room is characterized in,
that acoustic properties of the room are determined,
that modifications of the acoustic properties of the room are detected,
that the modifications are compared to preset criteria and
that an action is triggered, when the preset criteria are met.

An embodiment according to the method of the present invention consists in that a transfer function of the room is estimated as an acoustic property with the help of an adaptive process.

A further embodiment according to the method of the present invention consists in that the modification corresponds to a modification of the estimated transfer function.

A yet another embodiment of the method according to the present invention consists in that an error signal is generated from an actual output signal and an estimated output signal and that a modification of the estimated transfer function is carried out as a result of the error signal.

A further embodiment of the method according to the present invention consists in that the acoustic properties of the room are determined continuously. Thereby, the possibility is given that it can be differentiated between “big” and “small” modifications, which additionally opens up the possibility, that people can move in the room to be surveyed. Naturally a modification of the transfer function results as well, when people are moving in the surveyed room. However, the modifications are not as big as when a window or a door to the room is opened or closed, respectively. In this case, the first mentioned modification is considered to be “small” in the aforementioned sense, whereas the second mentioned modification can be considered as “big”. Furthermore, it can also be distinguished, whether it is about people or domestic animals in such a constellation, a modification, which is caused by a person, being interpreted as “big” and a modification, which is caused by a domestic animal, being interpreted as “small”.

A further embodiment of the method according to the present invention consists in that an acoustic input signal, preferably a white noise, is emitted into the room for the determination of the acoustic properties of the room. This is used in particular, but not solely, for the determination of the properties of the Secondary Path (influence of the components including stationary acoustic influences) with the help of an “offline” modeling to be illustrated yet.

Further, the method according to the present invention can be used in all embodiments for active noise reduction in a room.

Furthermore, a device for carrying out the method according to the present invention is given, by which means are provided for determination of acoustic properties of the room, a detection unit for detection of modifications of the acoustic properties of the room, means for comparison of the modifications with preset criteria and means for triggering an action, if the preset criteria are met.

A further embodiment of the device according to the present invention consists in estimating a transfer function of the room as acoustic property with the help of an adaptive process.

A further embodiment of the device according to the present invention consists in that the modification corresponds to a modification of the estimated transfer function.

A further embodiment of the device according to the present invention consists in that means are provided for generating an error signal from an actual output signal and an estimated output signal and that means are provided for effecting a modification of the estimated transfer function as a result of an error signal.

A further embodiment of the device according to the present invention consists in that means are provided for continuously adjusting of the acoustic properties of the room.

Finally, a further embodiment of the device according to the present invention consists in that means are provided for emission of an acoustic input signal into the room, preferably a white noise, in order to determine the acoustic properties of the room.

The method according to the present invention and the device according to the present invention can be used, on the one hand, for active noise reduction with the aid of so-called ANC (“Active Noise Cancelling”), on the other hand, it can be used for the survey of a room. In the following, two possible solutions are described thereto.

Methods and devices for active noise reduction are known. Reference is made to the German disclosure document with the number DE-43 08 923 A1 and the British Patent with the number 21 49 614.

Particular attention has to be directed on the so-called “Secondary Path”, which serves in active noise reduction systems for the imitation of the system properties. For the determination of the “Secondary Path”, either an “offline” modeling or an “online” modeling is used. For the “offline” modeling, the properties of the system including the room to be surveyed are determined by feeding white noise into a room and by detecting by a sensor—mostly a microphone is used thereto.

For the “online” modeling, the parameters are assessed during the operation. A complete active noise reduction system with integrated Secondary Path is described among other things in the document “A New Structure For Feed Forward Active Noise Control Systems With Online Secondary-Path Modeling”, which has been published by the authors Muhammad Tahir Akthar, Masahide Abe and Masayuki Kawamat on the occasion of the “International Workshop on Acoustic Echo and Noise Control (IWAENC2003)” in September 2003 in Kyoto.

The invention is further illustrated in the following by referring to drawings showing possible embodiments.

### BRIEF DESCRIPTION OF DRAWINGS

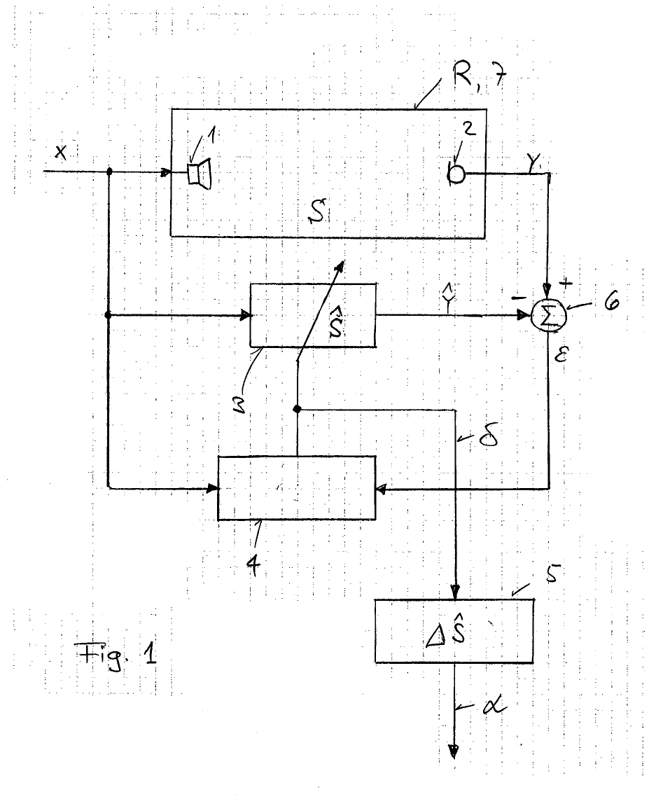

In FIG. 1, schematically, a block diagram of a first embodiment according to the present invention, and

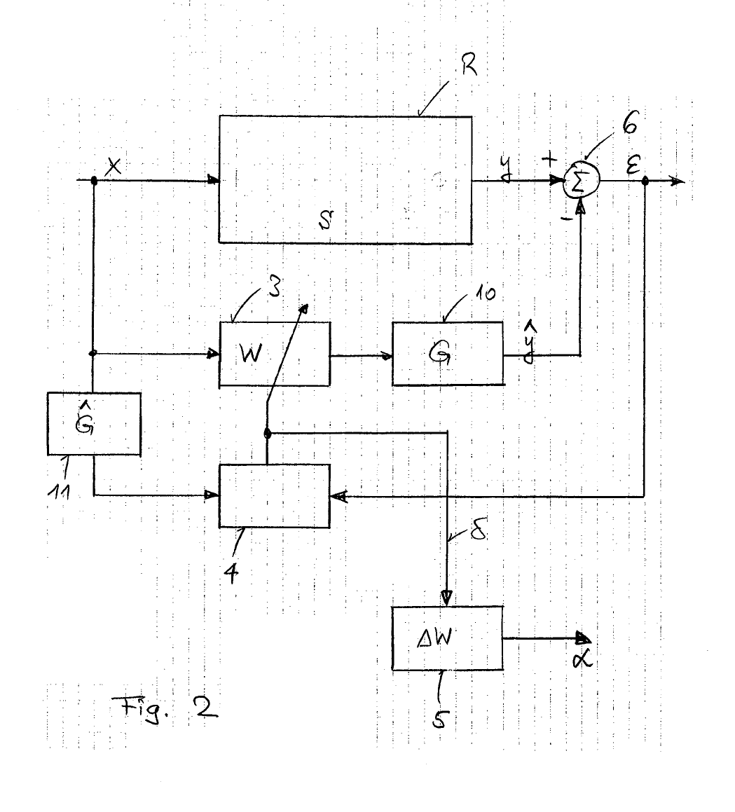

in FIG. 2, again schematically, a block diagram of a further embodiment according to the present invention.

### DETAILED DESCRIPTION

FIG. 1 shows a block diagram of an embodiment according to the present invention schematically. A room R to be surveyed with a transfer function S includes a loudspeaker unit 1 impinged by an input signal x and a microphone unit 2, by which an actual output signal y is generated. As has already been illustrated in detail in the introduction of the description, the transfer function S describes the acoustic behavior of the room R. Beside the acoustic behavior, transfer characteristics of the used components, are also included in the transfer function S, as the microphone unit 2 and the loudspeaker unit 1 (also called “influence of components”).

In connection with the mentioned microphone unit 2 and the loudspeaker unit 1, it is explicitly pointed out that, in general, it is not a matter of separate units—as depicted in FIG. 1. Rather, quite a number of microphone units and loudspeaker units are provided in order to describe the acoustic behavior of the room R entirely or as accurately as possible, respectively. In the same connection, it should be mentioned that any suitable actuators or sensors, respectively, can be used instead of loudspeaker units and microphone units. As a consequence, such variations are considered within the general definition for the terms “loudspeaker unit” and “microphone unit” in connection with the description of this invention.

The embodiment according to FIG. 1 comprises further a transfer unit 3, which comprises a model of the actual transfer function S—in the following named estimated transfer function \textcircled{S}—, an adaptive processor unit 4, an addition unit 6 and a detection unit 5, the input signal x next to the loudspeaker unit 1 being impinged on the transfer unit 3 as well as on the adaptive processor unit 4. In order to form an error signal ε, the actual output signal y and an output signal \textcircled{y} estimated by the transfer unit 3 are added in the addition unit 6, the estimated output signal \textcircled{y} being inverted in advance in order to obtain the difference of the two output signals y and \textcircled{y}. As a consequence, the error signal ε is impinged on the adaptive processor unit 4, in which the corrected coefficients 5 are generated to form the momentary estimated transfer function \textcircled{S}, which is fed to the transfer unit 3 as well as to a detection unit 5. The corrected coefficients δ can only be modifications in comparison to the coefficients of the estimated transfer function \textcircled{S} obtained in a previous computation step, for example, or the new coefficients of the estimated transfer function \textcircled{S}. The aim of the computations in the adaptive processor unit 4 is in both cases that the estimated output signal \textcircled{y} mostly corresponds to the actual output signal y. Thus, the target function of the computations is a minimization of the error signal ε.

As already mentioned, modifications (corrected coefficients δ) of the estimated transfer function \textcircled{S}—which correspond to the modifications of the actual transfer function S due to the system—are fed into the detection unit 5, in which an indication signal at is generated in function of the corrected coefficients δ. This means that an indication signal α or alarm signal, respectively, is generated in the detection unit 5 by using preset criteria of the corrected coefficients δ. By the indication signal α, any action can be triggered.

In a first embodiment, the estimated transfer function is determined in a so-called “offline” method by feeding a defined signal, a white noise for example, as input signal x into the transmission path to be modeled. The microphone unit 2 records the output signal y as a result of the acoustic properties of the room and compares it to the estimated output signal \textcircled{y}, which has be obtained by the estimated transfer function \textcircled{S}.

It is pointed out that FIG. 1 corresponds to a system for the determination of the Secondary Path. The room R, the transfer unit 3 and the adaptive processor unit 4 are supplied with the input signal x. The adaptive process running in the adaptive processor unit 4 adjusts the estimated transfer function \textcircled{S} in such a way that the difference formed in the addition unit 6 is minimized, i.e. the error signal ε. When the estimated transfer function \textcircled{S} of the adaptive process is adjusted in such a way that the error signal ε is minimal, the estimated transfer function \textcircled{S} describes the properties of the room R best. Ideally the error signal ε is equal to zero, resulting in that the estimated transfer function \textcircled{S} exactly corresponds to the actual transfer function S.

As soon as any condition changes in the room R by opening or closing a window or a door, for example, the error signal ε becomes bigger, whereon the adaptive process of the estimated transfer function \textcircled{S} in the transfer unit 3 running in the adaptive processor unit 4 changes in such a way that the error signal ε becomes minimal again. Due to this modification (i.e. as a result of the corrected coefficients δ) an appropriate action (intervention, alarm) can be triggered. Thereby, the detection unit 5 has the function to check the corrected coefficients δ on these criteria, which must be present in order to trigger an action. Thus, in the detection unit 5, a detection transfer unit Δ\textcircled{S} is defined, which determines magnitude, duration as well as frequency response of the adjustment or the correction of the estimated transfer function \textcircled{S}, respectively.

This makes it possible to react to specific modifications in the room R selectively. A modification effected through a time-orientated air conditioner can be ignored, for example.

By the embodiment of the invention depicted in FIG. 1, the acoustic properties of a room R can be detected very precisely. To that effect, an alarm system based on this principle can be adjusted accurately. In particular, this embodiment is excellently suitable for a survey of a room R, in which no people remain, and namely in particular, because an input signal x always has to be fed into the room R for a continuous survey, which perhaps can be disturbing to people remaining in the room.

A further embodiment of the present invention is depicted in FIG. 2. Therein, it is about a system, which is excellently suitable for noise reduction as well as for continuous survey of a room. Thereby, this further embodiment is in particular characterized in, that noise from the outside is present and that people to be surveyed and remaining in the room R do not get disturbed.

To begin with, a simple system for active noise reduction is depicted in FIG. 2 (“Active Noise Cancelling, shortly named ANC), which is used in a room R having a transfer function S and in which an estimated transfer function W is determined continuously.

The embodiment according to FIG. 2 comprises two transfer blocks in addition in comparison to the embodiment according to FIG. 1, namely a component transfer function G and an estimated component transfer function \textcircled{G}, the component transfer function G in the signal path for generating the estimated output signal \textcircled{y} and the estimated component transfer function \textcircled{G} being arranged on the side of the input signal x before the processor unit 4. The component transfer function G as well as the estimated component transfer function \textcircled{G} describe all influences inherent to the transfer path, which influences are derived from the following components, for example: loudspeakers, microphones, plug-in connections and the like. Thereby, the estimated component transfer function \textcircled{G} is a model of the component transfer function in order to compensate or to take into account, respectively, the properties represented by the component transfer function G in the computations.

The active noise reduction function is as follows: In detecting a noise x of the surroundings by a microphone unit positioned outside of the room R (not depicted in FIG. 2), the adaptive process running in the processor unit 4 adjusts an adjustable transfer function W in such a way that the error signal ε formed by the addition unit 6 from the noise signal (actual output signal y) and the estimated output signal \textcircled{y} is minimal.

To simplify matters, a loudspeaker unit as an actuator and a microphone unit as a sensor are utilized in the adaptive noise reduction system according to FIG. 2. Of course, also other actuators or sensors can be used at any number. For detecting the error signal ε microphone units or sensors, respectively, are used within the room R to be calmed or to be surveyed, respectively.

Now, the above described adaptive noise reduction system can be modified in such a way that it can be operated as an alarm system. This makes sense in an office, for example. During working hours, it fullfills its function as a noise reduction system and minimizes the noises of the surroundings, after work it functions as an alarm system.

As soon as the properties of the room Rare modified, the adaptive process running in the processor unit 4 is forced to modify the transfer function W anew. As a result of the correction or modification to be made, respectively, an action can again be triggered with the help of the detection unit 5. An alarm or an intervention can be triggered, for example. Thereby, the detection unit 5 has the function to check the coefficients δ of the estimated transfer function W on these criteria, which have to be present in order to trigger an action. A detection transfer function ΔW is therefore defined in the detection unit 5, which detection transfer function ΔW determines magnitude, duration as well as the frequency response of the correction or modification, respectively, to be made. This makes it possible to react to specific modifications in the room R, which makes the use in a bed room possible, for example. The modification by a person, which approaches to the bed or gets out of it, can be ignored; but when the volume of the bed room changes, because a door isopened, an alarm is triggered.

1. Method for surveying a room (R), comprising:
determining acoustic properties (\textcircled{S}, W) of a room (R),
detecting modifications (δ) of the acoustic properties (\textcircled{S}, W) of the room (R),
comparing the modification (δ) to preset criteria (Δ \textcircled{S}, ΔW), and
triggering an action (α), when the preset criteria (Δ \textcircled{S}, ΔW) are met.

2. Method according to claim 1, including estimating a transfer function (S) of the room (R) as an acoustic property with the help of an adaptive process.

3. Method according to claim 2, wherein the modification (δ) correspond to modifications of the estimated transfer function (\textcircled{S}, W).

4. Method according to claim 2, including
generating an error signal (ε) from an actual output signal (y) and an estimated output signal (\textcircled{y}), and
carrying out a modification of the estimated transfer function (\textcircled{S}, W) based on the error signal (ε).

5. Method according to claim 1, wherein the acoustic properties of the room (R) are determined continuously.

6. Method according to claim 1, including emitting white noise as an acoustic input signal (x), into the room (R) for the determination of the acoustic properties of the room (R).

7. Method according to claim 2, wherein the modifications (δ) are determined on the basis of coefficients of the estimated transfer function (\textcircled{S}, W).

8. Method for surveying a room (R), with an actual transfer function (S) with an input signal (x) and an actual output signal (y), comprising:
determining an estimated transfer function (\textcircled{S}, W) with the help of an adaptive process,
generating an error signal (ε) from an actual output signal (y) and an estimated output signal (\textcircled{y}),
on the basis of the error signal (ε) determining a correction (δ) of the estimated transfer function (\textcircled{S}, W) in such a way that the estimated transfer function (\textcircled{S}, W) corresponds to the actual transfer function (S) as much as possible,
generating an indication signal (α) in function of the correction (δ) of the estimated transfer function (\textcircled{S}, W).

9. Method according to claim 8, including using the method for the active noise reduction in the room (R).

10. Device for surveying a room (R), comprising:
means (1, 2, 3, 4, 6) for determining acoustic properties (\textcircled{S}, W) of the room (R),
a detection unit (5) for the detection of modifications (δ) of the acoustic properties (\textcircled{S}, W) of the room (R),
means (5) for comparing of the modifications (δ) to preset criteria (Δ \textcircled{S}, ΔW), and
means (5) for triggering an action (α), when the preset criteria (Δ \textcircled{S}, ΔW) are met.

11. Device according to claim 10, wherein said means for determining acoustic properties determines an estimated transfer function (\textcircled{S}, W) of the room (R) as acoustic property with the help of an adaptive process.

12. Device according to claim 11, wherein the modification (δ) correspond to modifications of the estimated transfer function (\textcircled{S}, W).

13. Device according to claim 11, further comprising:
means (6) for generating an error signal (ε) from an actual output signal (y) and an estimated output signal (\textcircled{y}), and
means (3, 4) for conducting modification of the estimated transfer function (\textcircled{S}, W) on the basis of the error signal (ε).

14. Device according to claim 10, wherein said means for determining acoustic properties continuously adjusts the acoustic properties of the room (R).

15. Device according to claim 10, wherein the means for determining acoustic properties includes means (1) for emitting of an acoustic input signal (x) as a white noise, into the room (R) in order to determine the acoustic properties of the room (R).

16. Use of the device according to claim 10 for active noise reduction as well as for surveying a room (R).

17. Method according to claim 1, including using the method for active noise reduction in the room (R).
